(19) United States
(12) Patent Application Publication
(10) Pub. No.: US 2010/0255234 A1
(43) Pub. Date: Oct. 7, 2010

(54) Pressure Tank and Method and Blow-Molding Station for the Production Thereof

(75) Inventor: Claus-Dieter Koetke, Bad Bodenteich (DE)

Correspondence Address: EDELL, SHAPIRO & FINNAN, LLC, 1901 RESEARCH BOULEVARD, SUITE 400, ROCKVILLE, MD, 20850, US

(73) Assignee: KUNSTSTOFFVERARBEITUNG KOETKE GMBH, Reinstorf (DE)

(21) Appl. No.: 12/752,392

(22) Filed: Apr. 1, 2010

(30) Foreign Application Priority Data
Apr. 2, 2009 (DE) 102009015964.9

(51) Int. Cl. B29C 49/20; B28B 21/70; B28B 21/36; B32B 1/00

(52) U.S. Cl. 428/35.8; 264/540; 425/503

(57) ABSTRACT

A pressure tank blank made of a thermoplastic, having a body, which merges via a shoulder into a neck and a mouth, which is implemented for screwing in a valve, is usable for gases under high pressure, if the blank has a metal insert enveloped by the plastic on the interior to reinforce at least the shoulder of the blank. This pressure tank blank may be produced in an extrusion blow-molding method. For this purpose, with open blow mold, a metal insert having the inner contour of at least the shoulder of the blank is introduced into the corresponding area of the cavity of the blow mold and the tube, enclosing this metal insert, is extruded into the blow mold, before it is closed.

### CROSS REFERENCE TO RELATED APPLICATIONS

The present application claims priority under 35 U.S.C. §119 to Application No. DE 102009015964.9 filed on 2 Apr. 2009, entitled “Pressure Tank Blank and Method and Blow Molding Station for the production Thereof,” the disclosure of which is hereby incorporated by reference in its entirety.

### FIELD OF THE INVENTION

The present invention relates to a pressure tank and, in particular, to a thermoplastic pressure tank blank having a reinforcing strip to prevent bursting of the blank under pressure. Furthermore, the invention relates to a method of forming the pressure tank blank, and a blow-molding station for the production of the pressure tank blank.

### BACKGROUND

Pressure tanks based on a blank made of thermoplastic are used to store and discharge fluids such as propane or butane. At normal ambient temperatures, the typical equilibrium state results between the predominant liquid phase and the gas phase of the relevant fluid. Such cost-effective pressure tanks, which are typically bottle-shaped or cartridge-shaped and having a circular cross-section, have proven themselves for small volumes up to several hundred milliliters. Concerns have existed up to this point about use for larger volumes and/or for gases such as hydrogen as well, which generate a significant internal pressure in the pressure tank at ambient temperature, because a pressure tank of this type made of a reinforced plastic blank does have a high static bursting strength, but is in danger of breaking in the event of specific dynamic loads, as occur during the drop test, for example. A further weak point is the seal between the neck or the mouth of the tank and the screwed-in valve, because neither an increase of the tank wall thickness nor the described reinforcement may solve the problem of making the connection between the tank and the screwed-in valve reliably tight and resistant to being torn out.

While the weak points of the blank may be externally reinforced by a special further reinforcement (e.g., via an external reinforcement in the form of a winding made of high tensile strength fibers impregnated with artificial resin), such approaches have proven to be extremely uneconomical.

Thus is would be desirable to provide a pressure tank having a reinforcing strip that reduces the risk of a tank bursting when under pressure.

### SUMMARY OF THE INVENTION

A pressure tank blank for a handling-safe pressure tank is disclosed. The blank includes a body and a mouth that threadingly engage a closure element such as a valve. The blank includes a metal insert disposed on the interior of the body, proximate the neck. The blank is adapted to reinforce at least the shoulder of the blank. After reinforcement and attaching of the valve, the resulting tank is usable for large volumes of liquid gas and/or gases under high pressure, in particular, hydrogen.

This solution is based on our finding that the most endangered area of a thermoplastic pressure tank is designated as the shoulder (i.e., the area that is typically externally reinforced along the transition from the tank body into the container neck). The internal reinforcement using a metal insert is significantly more favorable in relation thereto, because it can be integrated into the blow-molding method of the tank blank. The metal insert preferably has openings which are filled by the plastic. Uniform precise centering of the metal insert in relation to the container cross-section in this area is thus achieved.

A refinement, which ensures a secure seat of the metal insert even in the event of strong impacts acting on the tank and other mechanical shocks, is that the cross-section of the openings of metal insert widens from the exterior to the interior of the blank. The openings thus form undercuts penetrated by the plastic. In a particularly preferred embodiment, the metal opening extends up to the mouth at the end of the neck of the blank. As a result, the neck area of the blank is thus also particularly resistant to bending and shear forces acting externally on the neck. A further improvement of the fixation of the metal insert on the inner contour of the blank may be achieved in that the metal insert has a profiled surface at least in the area of the neck (e.g., the base portion of metal insert may be contoured to the interior surface of the neck and/or neck portion of the metal insert may be contoured to the blank neck).

The problem of ensuring a tight connection between the tank and the valve, which naturally results in particular in tanks under high internal pressure, disappears if the metal insert has an internal thread for threadingly engaging the threads of a valve in the mouth area, because a metal internal thread is significantly more dimensionally stable and has greater long-term stability than an internal thread in a thermoplastic.

A further improvement of the bursting strength is achieved if the blank has a metal spherical cap enveloped by the plastic on its floor area opposite to the neck. This metal spherical cap is thus more or less the counterpart of the metal insert on the neck or mouth side. For better fixation, the metal spherical cap can therefore have openings, which are filled by the plastic like those of the metal insert, and are optionally also undercut.

Furthermore, the metal spherical cap can also have a threaded nipple in the middle having an internal thread. This embodiment is particularly suitable for pressure tanks which are not filled via the neck-side valve, but rather via a floor opening, which is subsequently closed using a threaded stopper.

A method for producing a pressure tank blank from plastic may include the following steps: extruding a tube made of a thermoplastic from an extrusion die into an open blow mold, whose cavity is the negative of the blank; closing the blow mold and introducing compressed air to shape the blank; opening the blow mold after a cooling time and removing the blank. According to this method, pressure tank blanks of the present invention may be produced cost-effectively but having significantly improved strength when a metal insert having the inner contour of at least the shoulder of the blank is introduced into the corresponding area of the cavity when the blow mold is open and the tube, enclosing this metal insert, is extruded into the open blow mold.

A refinement of this method, in which the blank is shaped having a mouth pointing downward, is distinguished in that the metal insert is introduced from below into the open blow mold using a core rod which can be raised and lowered.

A further improvement of the strength of the blank and thus also of the later pressure tank is achieved in one embodiment of the method, in which a metal spherical cap having the inner contour of at least the floor of the blank is introduced into the corresponding area of the cavity when the blow mold is open and the tube, enclosing the metal spherical cap, is extruded into the open blow mold.

The method is particularly efficient if the metal spherical cap for the floor of the blank is introduced into the open blow mold from below, together with the metal insert for its neck area, using the same core rod.

If the blow mold is to be brought into a separate blowing station for shaping the blank in order to shorten the cycle time, a variant of the method is expedient in which the tube extruded into the open blow mold is kept open using partial vacuum in the area of its entry into the blow mold and is cut through above this, the blow mold is subsequently moved out of its position below the extrusion die into the separate blowing station, and a metal spherical cap having the inner contour of at least the floor of the blank is introduced from above into the open blow mold in the area of the cavity corresponding to the floor using a core rod which can be raised and lowered. This dispenses with additionally equipping the core rod carrying the metal insert with the metal spherical cap, allows the use of a correspondingly shorter core rod, and simultaneously permits the choice of implementing the lower or the upper core rod as a blow pin for shaping the blank.

A blow-molding station for producing a pressure tank blank of this type according to the above method comprises a longitudinally-divided blow mold, which comprises at least two mold parts movable relative to one another for opening and closing the blow mold, which together delimit a cavity, which is the negative of the blank having vertical central axis and mouth pointing downward, further has a blow pin which can be raised and lowered for shaping the blank from an extruded thermoplastic tube and is distinguished according to the invention in that the blow pin is situated below the blow mold and is implemented as a holder for the metal insert, which has the inner contour of at least the shoulder of the blank.

The blow pin preferably has radially movable clamping elements to hold the metal insert and to release the blank after the blowing out.

Furthermore, the blow pin can have an extension reaching up to the floor of the blank, which is implemented as a holder for a metal spherical cap, which reinforces the floor of the blank.

An embodiment of the blow-molding station which is suitable for producing a pressure tank blank, which can be reinforced in both the neck area and also in the floor area, is distinguished in that the blow mold has, on the entry side of the plastic tube, mobile mold upper parts which can be moved together relative to the movable mold parts, having an inner contour for implementing the floor of the blank and slides having suction openings for keeping open the cut-off upper end of the plastic tube above these mold upper parts, and a core rod which can be raised and lowered is situated over the blow mold, which is implemented as a holder for metal insert corresponding to the inner contour at least of the shoulder area and/or for a metal spherical cap having the inner contour of at least the floor of the blank.

The core rod over the blow mold can be implemented as a blow pin, in which case a simple core rod is situated as a holder for the metal insert instead of the blow pin situated below the blow mold.

Conventional thermoplastics suitable for pressure tank blanks of this type, which may particularly also be extruded as a tube having multiple layers of varying function, may be utilized to form the tank.

### BRIEF DESCRIPTION OF THE DRAWINGS

FIG. 1a illustrates a cross-sectional view of the pressure tank blank in accordance with an embodiment of the invention.

FIG. 1b illustrates a close-up view of the area designated “X” in FIG. 1B.

FIG. 2 illustrates a cross sectional view of an open blow mold for generating the blank in accordance with an embodiment of the invention, as well as a partial cross-sectional view of a thermoplastic tube section disposed within the open blow mold.

FIGS. 3a, 3b, and 3c illustrate close-up, cross-sectional views of the blow mold shown in FIG. 2, showing the steps for shaping the neck and mouth areas of the pressure tank blank according to FIG. 1a.

FIG. 4 illustrates the finished shaped pressure tank blank before the ejection from the blow mold.

FIG. 5 illustrates a cross-sectional view of a pressure tank blank in accordance with another embodiment of the invention, showing a pressure tank blank with an opening in the floor and having a blow pin shown by dashed lines for explanation.

FIG. 5a illustrates a partial view the floor area of a pressure tank blank in accordance with another embodiment of the invention.

FIGS. 6a through 6e illustrate sequential steps for the production of the pressure tank blank of FIG. 5.

Like reference numerals have been used to identify like elements throughout this disclosure.

### DETAILED DESCRIPTION OF THE INVENTION

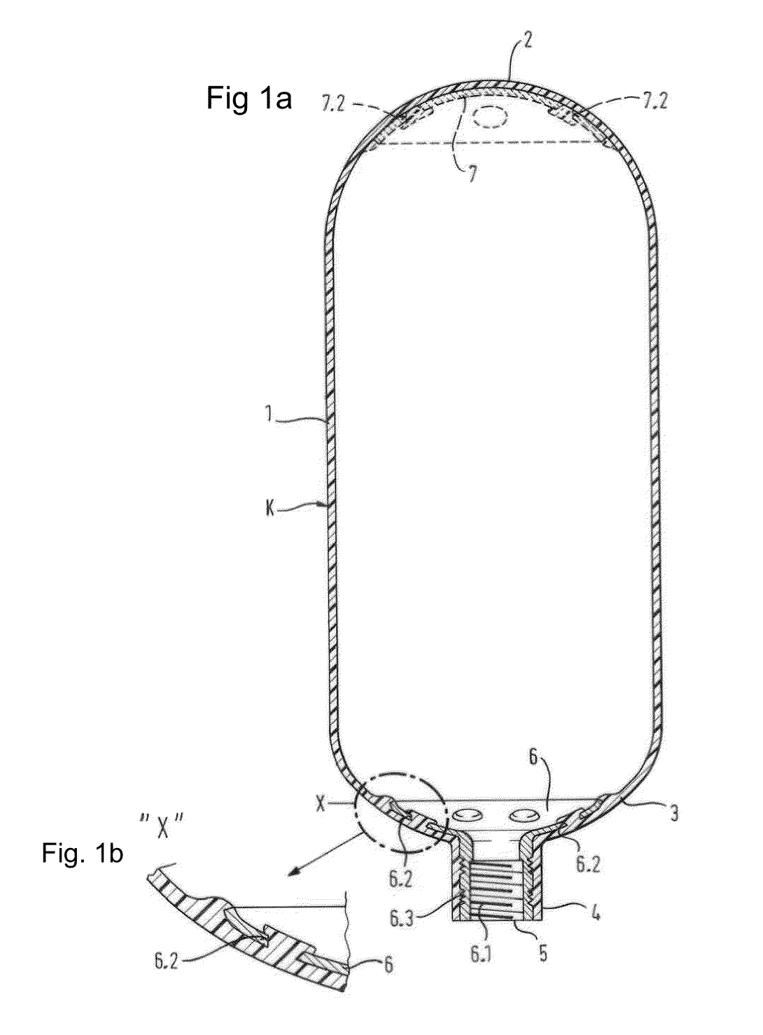

The pressure tank blank shown in longitudinal section in FIGS. 1a and 1b comprises an approximately bottle-shaped plastic hollow body, generated in a blow-molding method explained hereafter, made of an optionally multilayered thermoplastic K. The blank has a body 1 having circular cross-section, a floor 2 in the form of a spherical cap, and a shoulder 3, which merges into a neck 4 having an opening or mouth 5.

The blank includes an interior metal insert 6, which is enveloped by the thermoplastic K and extends up to the mouth 5 of the blank, in the area of its shoulder 3. The metal insert 6 has an internal thread 6.1 for screwing in a closure element (not shown), in particular a valve. The metal insert 6 can extend up to the transition of the shoulder 3 into the body 1, notwithstanding the illustration in FIG. 1.

In order to produce a reliable non-positive connection between the metal insert 6 and the plastic K, the metal insert 6 has openings 6.2 at least in the area of the shoulder 3, which may additionally be undercut as shown in the detail “X” (FIG. 1b) so that they widen from the exterior to the interior of the blank. During the blow molding of the blank, a part of the plastic K enters into the corresponding area through the opening 6.2 and expands such that, after the cooling of the plastic K, a rivet-like connection results at these points. The metal insert 6 also has a toothed exterior surface 6.3 at least regionally in the area of the neck 4 for the close connection of the metal insert to the plastic K (e.g., the teeth bite into the plastic).

As a function of the internal pressure to which the pressure tank blank is subjected later, after the filling, it can be advisable to similarly reinforce the floor 2, which is fundamentally less in danger of breaking and/or bursting, as shown by dashed lines, using a metal spherical cap 7. The metal spherical cap 7 has openings 7.2 corresponding to the opening 6.2 of the metal insert 6 for the close connection to the plastic K, for the passage of a corresponding small quantity of the plastic K to create connection points similar to that described above.

The final pressure tank differs from the blank shown in FIGS. 1a and 1b, which is reinforced at least in the shoulder and neck areas, only through an additional external reinforcement, e.g., made of fiberglass fabric impregnated with artificial resin, and a valve or closure element (not shown) threaded pressure-tight into the mouth 5.

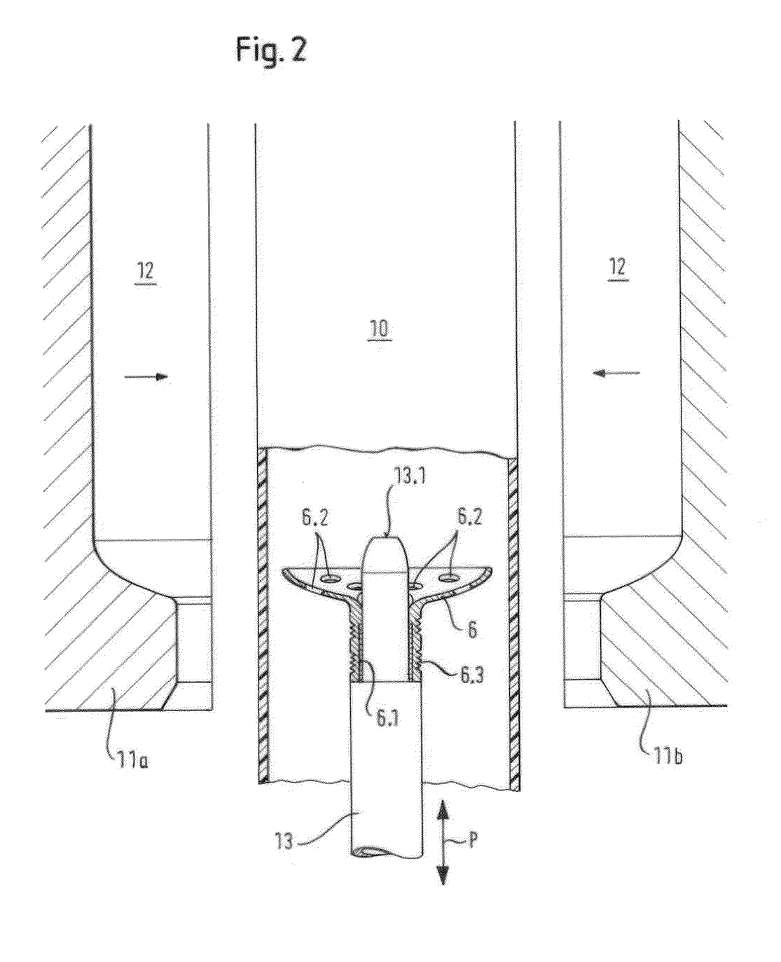

The blank of FIG. 1a, with or without the optional metal spherical cap 7, may be produced utilizing a blow molding process with an extruded, thermoplastic tube. This process is schematically shown in FIGS. 2, 3a through 3c, and 4.

FIG. 2 schematically shows the opened halves 11a and 11b of the lower part of a blow mold whose cavity 12 is the negative of the pressure tank blank. A blow pin 13, which also serves as a carrier for the metal insert 6, is inserted from below the blow mold (between the opened halves 11a and 11b). The blow pin 13, which includes an upward directed frontal blowing air opening 13.1, can be raised and lowered into the blow mold (indicated by double arrow P). In the raised position of the blow pin 13 shown, a tube 10 is extruded to beyond the lower end of the blow mold from a typical extrusion die (not shown) situated above the blow mold. In addition, the blow pin 13 may include radially-movable clamping elements (not shown) for the metal insert 6, alternatively or additionally to the diameter steps shown, on which the lower, annular front surface of the metal insert 6 is seated.

The tube 10 can be single-layer or can comprise multiple, coextruded layers of different thermoplastic. The diameter of the thermoplastic tube 10 is typically somewhat less than the diameter of the later blank in the area of its body 1.

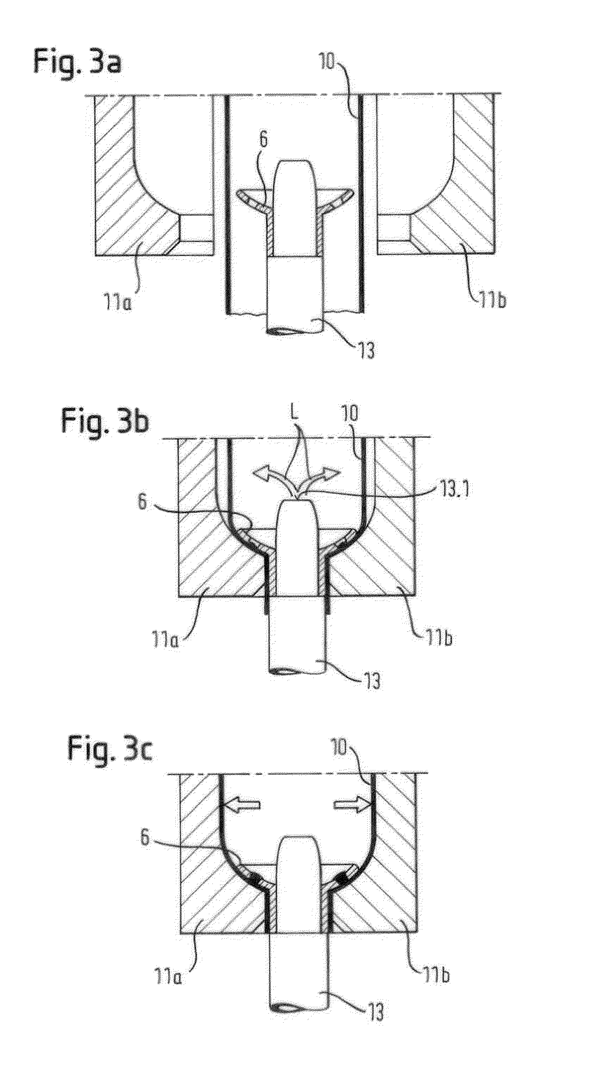

Referring to FIG. 3a, the part of the blow mold halves 11a, 11b shaping the neck area begin in an open position as a half section. In FIG. 3b, the blow mold is closed. Compressed air is injected into the interior of the tube 10 (indicated by arrow L) via the blow pin 13. The tube 10 thus presses against the wall of the cavity of the blow mold. The close connection between the metal insert 6, the corresponding area of the shoulder 3, and in the area of the neck 4 of the blank results simultaneously.

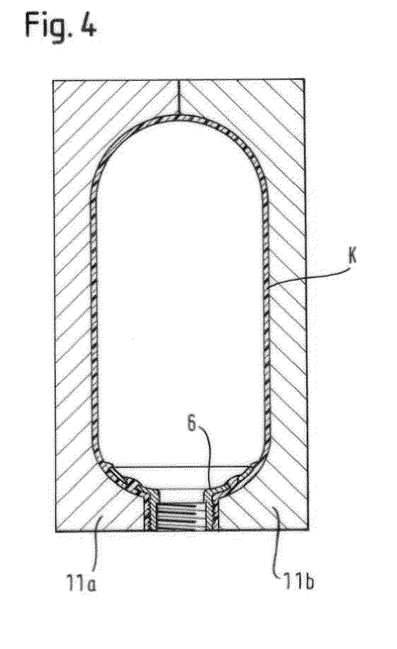

FIG. 4 shows the finished blank within the still closed blow mold, from which it is unmolded by moving apart the blow mold 11a, 11b after the typical cooling time. In these and in all other schematic illustrations, the parts of the blow mold and their halves 11a, 11b that are conventional are not illustrated or explained (e.g., the drives, the cooling channels, and the pinch edges and the cavities for receiving the displaced and pinched-off plastic material). These parts and their operation are generally known to those skilled in the art.

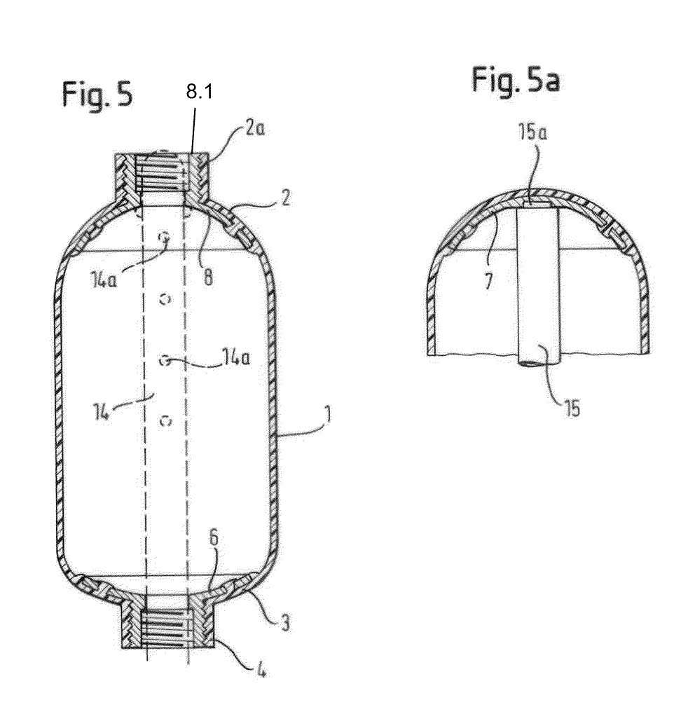

The embodiment of the pressure tank blank shown in FIG. 5 has, in addition to the metal insert 6 situated in the shoulder and neck area of the blank, a second reinforcement in the form of a metal spherical cap 8 disposed in the area of the floor 2. The metal spherical cap possesses a structure similar to that of the metal insert 6. In this embodiment, the floor 2 includes a central connecting piece 2a in the middle, which encloses a threaded nipple 8.1 in one piece with the metal spherical cap 8. The nipple can have an internal diameter deviating from the diameter of the mouth 5 of the blank 1, but also has an internal thread, an externally toothed surface in the area of the connecting piece 2a and anchoring openings penetrated by the plastic, similar to that disclosed for the metal insert 6.

To produce the blank, the metal spherical cap 8 is introduced from below into the blow mold using a long blow pin 14. The blow pin 14 can be raised and lowered like the blow pin 13 in FIG. 2. On its upper end, it carries the metal spherical cap 8 either on a peripheral diameter step or on radial clamping elements, which may be actively extendable and retractable. In its lower area, the blow pin 14 has corresponding holding means for the metal insert 6 (e.g., passive or active clamping elements or a diameter step similar to the blow pin 13 in FIG. 2). The blow pin 14 is provided with a suitable number of radial blowing air openings 14a. The blowing and shaping process runs similarly to that of FIGS. 3a through 3c.

The floor area of an embodiment of the blank which is simplified in relation to FIG. 5 is shown in FIG. 5a. In the illustrated embodiment, the metal spherical cap 7 does not have a central opening for a threaded nipple. This metal spherical cap 7 is introduced using a blow pin 15, which essentially corresponds to the blow pin 14 in FIG. 5, but only has a centering attachment 15a on the front end, which cooperates with a centering depression in the metal spherical cap 7, so that it is held securely at the predefined location, until the blank is completely inflated. Other types of secure connection, which can be detached by retracting the blow pin 14, of the core rod to the metal spherical cap 7 are also suitable.

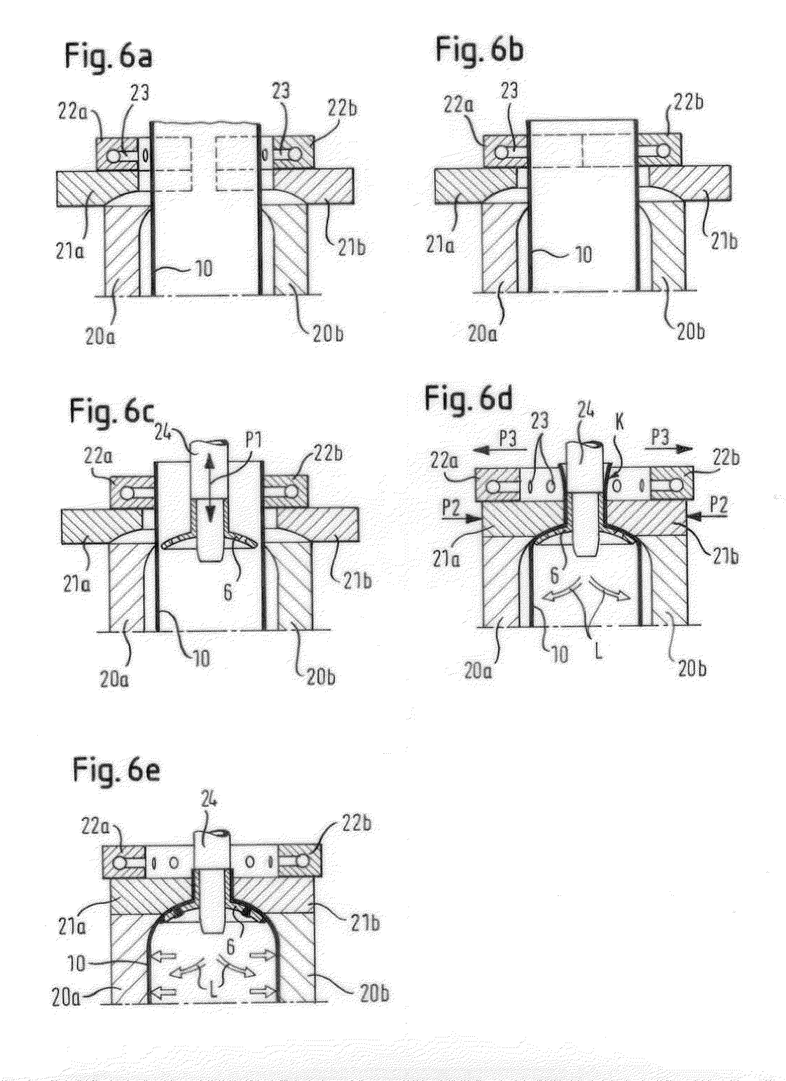

An alternative method for the production of the pressure tank blank is illustrated in FIGS. 6a through 6e. While the blanks according to FIGS. 1 through 5a are produced in a divided blow mold located fixed in place under the extrusion die (not shown), the method illustrated by FIGS. 6a through 6e allows a shorter cycle time in relation thereto, in that the blow mold is moved into a separate blowing station from its position under the extrusion nozzle after the introduction of the tube. In this variant, the blank is generated differently than in the method according to FIGS. 2 through 5 having the mouth pointing upward.

The blow mold is constructed symmetrically to the mold partition line. Only the upper area is shown in the half section. A first or left independent mold upper part 21a, which translates laterally (being movable in the same direction), is situated above a first or left movable mold half 20a on the entry side of the plastic tube 10. A first or left independently movable slide 22a, which is located above the first mold upper part 21a, also translates laterally (moving in the same direction). The first movable slide 22a includes suction openings 23.

Similarly, the blow mold includes a second or right independent mold upper part 21b disposed over a second or right movable mold half 20b, and a second or right movable slide 22b located over the second mold upper part 21b.

In FIG. 6a, this blow mold is located below the extrusion die (not shown) in the open position of the above-mentioned parts. The plastic tube 10 is extruded from the extrusion die into the open mold.

After the extrusion of a sufficient length of the tube, the first slide 22a and its counterpart second slide 22b move together to the diameter of the tube, cf. FIG. 6b. A partial vacuum is simultaneously applied to the suction openings 23. The relevant area of the tube 10 is thus held and can now be cut off above the slides 22a, 22b using, e.g., a cutter or a glow wire.

The blow mold is moved into a separate blowing station in FIG. 6c. The blowing station has a core rod 24 which can be raised and lowered (indicated by arrow P1), on whose lower end the metal insert 6 may be held using radial clamping elements. The core rod 24 is lowered into the position shown. The core rod 24 may also function as a blow pin.

Referring to FIG. 6d, the first mold upper part 21a moves together with its counterpart second mold upper part 21b (indicated by arrow P2), in order to close the cavity of the blow mold and to press the plastic K against the neck area of the metal insert 6. The first 22a and second 22b slides can simultaneously retract (indicated by arrow P3) after cancellation of the partial vacuum at the suction openings 23.

At this point, support air is applied to the core rod 24 (indicated by arrow L), and, as shown in FIG. 6e, the blowing of the blank is finished in the now closed cavity (also indicted by arrows L).

Using a correspondingly lengthened core rod 24 and suitable holding means on the end, the same method is also possible for producing a blank having a reinforced floor and additional threaded nipple according to FIG. 5 or only having a reinforced floor according to FIG. 5a. In the first case, the core rod 24 can be implemented purely as a holding core rod. A metal spherical cap corresponding to the metal spherical cap 8 in FIG. 5 can be introduced from below using a blow pin 13 as in FIG. 2, which carries the metal spherical cap 8 instead of the metal insert 6, however.

The blank can also be produced similarly to FIG. 6a through 6e, but in the orientation as in FIGS. 1 and 2. The (upper) core rod 24 then only carries the metal spherical cap as 7 or 8. A lower core rod, which can be a blow pin as 13 in FIG. 2, positions the metal insert for the shoulder and neck area of the pressure tank blank.

What is claimed is:

1. A pressure tank blank formed of thermoplastic, the blank comprising:
a body, a shoulder, and a neck including a mouth configured to threadingly mate with a valve; and
a metal insert enveloped by the thermoplastic, wherein the metal insert is disposed within the interior of the blank to reinforce at least the shoulder of the blank.

2. The blank according to claim 1, wherein the metal insert has openings filled by the thermoplastic.

3. The blank according to claim 2, wherein the cross-section of the metal insert openings widens from the exterior to the interior of the blank.

4. The blank according to one of claim 1, wherein the metal insert reaches up to the mouth disposed at an end of the neck of the blank.

5. The blank according to claim 1, wherein the metal insert has a profiled surface at least in the area of the neck of the blank.

6. The blank according to claim 1, wherein the metal insert includes an internal thread that threadingly engages the valve in the mouth area.

7. The blank according to claim 1, wherein:
the blank includes a floor area oriented opposite the neck;
the blank further comprises a metal spherical cap disposed in the floor area of the blank, wherein the metal spherical cap is enveloped by the thermoplastic.

8. The blank according to claim 7, wherein the metal spherical cap encloses a nipple having an internal thread.

9. A method for producing a pressure tank blank whose body merges via a shoulder into a neck and a mouth, the mouth threadingly mating with a valve, the method comprising:
extruding a tube formed from thermoplastic into an open blow mold having a cavity that is a negative of the blank;
closing the blow mold and introducing compressed air to shape the blank;
opening the blow mold after a cooling time and removing the blank; and
introducing a metal insert having the inner contour of at least the shoulder of the blank into a corresponding area of the cavity,
wherein the tube, enclosing the metal insert, is extruded into the open blow mold.

10. The method according to claim 9, wherein:
the blank is shaped with the mouth pointing downward; and
the metal insert is introduced from below into the open blow mold using a core rod which can be raised and lowered.

11. The method according to claim 9, further comprising:
introducing a metal spherical cap having the inner contour of at least the floor of the into the corresponding area of the cavity while the blow mold is open;
extruding the tube into the open blow mold such that it encloses the metal spherical cap

12. The method according to claim 11, wherein the metal spherical cap for the floor of the blank is introduced from below into the open blow mold, together with the metal insert for its neck area, using a core rod.

13. The method according to claim 9, wherein:
the tube extruded into the open blow mold is held open using partial vacuum in the area of its entry into the blow mold and is cut through above this area;
the blow mold is moved from a position below the extrusion die into a blowing station, and
a metal spherical cap having the inner contour of at least the floor of the blank is introduced into the area of the cavity corresponding to the floor from above into the open blow mold using a core rod which can be raised and lowered.

14. A blow-molding station for producing a pressure tank blank having a body that merges via a shoulder into a neck and a mouth, which threadingly engages a valve, the blow molding station comprising:
a longitudinally divided blow mold including a first mold part and a second mold part, wherein the mold parts are movable relative to one another for opening and closing the blow mold;
a cavity delimited by the mold parts, the cavity defining the negative of the blank and having vertical central axis and mouth pointing downward; and
a blow pin that can be raised and lowered, wherein the blow pin shapes the blank from an extruded thermoplastic tube,
wherein the blow pin is situated below the blow mold and is implemented as a holder for a metal insert, which has the inner contour of at least the shoulder of the blank.

15. The blow-molding station according to claim 14, wherein the blow pin has holding mechanism operable to hold and release the metal insert.

16. The blow-molding station according to claim 14, wherein the blow pin comprises an extension reaching up to a floor of the blank, which is implemented as a holder for a metal spherical that reinforces the floor of the blank.

17. The blow-molding station according to claim 14, wherein:
the blow mold further comprises first and second mold upper parts disposed on an entry side of the plastic tube, wherein the mold upper parts are movable relative to the movable mold parts and can be moved together;
the mold upper parts cooperate to define an inner contour for implementing the neck or the floor of the blank, and wherein each mold upper part comprises slides having suction openings for holding open the cut-off upper end of the plastic tube above the mold upper parts; and
a core rod configured to be raised and lowered, the core rod being situated over the blow mold, wherein the core rod holds a metal insert or metal spherical cap for the interior reinforcement of endangered areas of the blank.

18. The blow-molding station according to claim 17, wherein:
the core rod over the blow mold comprises a blow pin; and
instead of a blow pin situated below the blow mold, a core rod is situated as a holder for the metal insert.

19. A thermoplastic blank for forming a high pressure tank, the blank comprising:
a floor section;
a body section extending distally from the floor section, the body possessing a diameter;
a shoulder section defined by tapered portion leading from the body section to a neck section, the neck section defined by an annular structure having a diameter smaller than the body diameter, wherein the neck section defines a port configured to mate with an enclosure element; and
a metal insert disposed within the blank such that it is connected to the tank along an interior surface of the shoulder, wherein the metal insert reinforces the neck section of the blank.

20. The thermoplastic blank of claim 1, wherein the metal insert includes:
a base portion having an first surface in contact with an interior surface of the blank and a second surface opposite the first surface;
a plurality of holes formed into the base portion, wherein the holes taper inward in a direction from the first surface to the second surface, the holes permitting the passage of thermoplastic therethrough; and
a neck portion extending distally from the base portion and oriented within the blank neck section, wherein the neck portion comprises
an internally threaded channel operable to mate with the enclosure element, and
external teeth formed into a neck exterior surface, wherein the teeth frictionally engage the neck section of the blank.
